(19) United States
(12) Patent Application Publication
(10) Pub. No.: US 2025/0286958 A1
(43) Pub. Date: Sep. 11, 2025

(54) IMAGE PROCESSING APPARATUS PRESENTING ERROR SOLUTION METHOD, CONTROL METHOD THEREFOR, AND STORAGE MEDIUM STORING CONTROL PROGRAM THEREFOR

(71) Applicant: CANON KABUSHIKI KAISHA, Tokyo (JP)

(72) Inventor: KAZUTAKA SHINAGAWA, Ibaraki (JP)

(21) Appl. No.: 18/981,080

(22) Filed: Dec. 13, 2024

(30) Foreign Application Priority Data
Mar. 5, 2024 (JP) 2024-033092

(51) Int. Cl. H04N 1/00; G06F 3/12

(52) U.S. Cl. CPC H04N 1/00029; G06F 3/1273; H04N 1/00413

(57) ABSTRACT

An image processing apparatus that can explicitly indicate a solution that likely solves an error symptom occurring in an image processing apparatus to a user. The image processing apparatus executes at least one function about an image process in response to a user operation. The image processing apparatus including a memory device that stores a set of instructions, and at least one processor that executes the set of instructions to display diagnostic menus describing error symptoms, which may occur in the image processing apparatus, related to the at least one function so as to be selectable by a user, perform, when the user selects one of the diagnosis menus displayed, a diagnosis process corresponding to an error symptom described in the diagnosis menu selected by the user, and determine a display method of the diagnostic menus according to a state of the image processing apparatus.

### BACKGROUND OF THE INVENTION

### Field of the Invention

The present invention relates to an image processing apparatus that presents a solution method corresponding to an error symptom that is occurring, a control method therefor, and a storage medium storing a control program therefor.

### Description of the Related Art

Conventionally, an image processing apparatus (hereinafter, simply referred to as an MFP) having a plurality of functions (printing, image transmission, facsimile, etc.) related to image processing may cause an error termination during execution of these functions and may cause an error symptom in which an output product is not as expected even in terminating normally.

In such cases, a user may not be able to reach a solution by oneself, even if the user tries to fix an error by checking online and offline product manuals and FAQs. In this case, the user may inquire of a call center, and if the error symptom still exists, the user can request dispatch of a service person to solve the error symptom.

In order to reduce such inquiries to the call center and dispatch of a service person, a function of enabling a user to reach a solution for the error symptom by oneself is required.

As a conventional technique, a method of presenting an error symptom occurring in an MFP and a plurality of adjustment items that may solve the error symptom in association with each other on a UI is proposed (see, for example, Japanese Patent Laid-Open Publication No. 2021-39425 (JP 2021-39425A, Counterpart of U.S. Ser. No. 11/650,530 B2)). Further, a method of providing a dynamic online manual corresponding to the device setting status at that time has been proposed as a conventional technique (see, for example, Japanese Patent Laid-Open Publication No. 2022-54963 (JP 2022-54963A)).

Although the technique of JP 2021-39425A presents the plurality of adjustment items that may solve the error symptom, the user needs to select an adjustment item that matches the error symptom from among the plurality of presented adjustment items in order to solve the error symptom.

Further, the technique of JP 2022-54963A provides only a function manual corresponding to the device setting status, and thus there is a problem that the user cannot solve the problem by oneself when an error symptom occurs in the MFP.

### SUMMARY OF THE INVENTION

The present invention provides a technique that can explicitly indicate a solution that likely solves an error symptom occurring in an image processing apparatus to a user.

Accordingly, an aspect of the present invention provides an image processing apparatus that executes at least one function about an image process in response to a user operation, the image processing apparatus including a memory device that stores a set of instructions, and at least one processor that executes the set of instructions to display diagnostic menus describing error symptoms, which may occur in the image processing apparatus, related to the at least one function so as to be selectable by a user, perform, when the user selects one of the diagnosis menus displayed, a diagnosis process corresponding to an error symptom described in the diagnosis menu selected by the user, and determine a display method of the diagnostic menus according to a state of the image processing apparatus.

According to the present invention, a solution that likely solves an error symptom occurring in an image processing apparatus can be explicitly indicated to a user.

Further features of the present invention will become apparent from the following description of exemplary embodiments with reference to the attached drawings.

### BRIEF DESCRIPTION OF THE DRAWINGS

FIG. 1 is a block diagram showing a hardware configuration of an MFP as an image processing apparatus of the present invention.

FIG. 2 is a view showing an example of a top screen displayed on a display in FIG. 1 for a user to instruct diagnosis corresponding to an error symptom.

FIG. 3 is a view showing associations between diagnosis IDs and error codes that define contents of diagnostic process performed by pressing diagnosis menus shown in FIG. 2, and functions and error symptoms that are indicated in the respective diagnostic menus.

FIG. 4A is a view showing an example of a guidance display screen displayed on the display in a case of a board failure.

FIG. 4B is a view showing an example of a guidance display screen displayed on the display in a case of line cable disconnection.

FIG. 4C is a view showing an example of a guidance display screen displayed on the display in a case of circuit type mismatch.

FIG. 5 is a flowchart showing a preferential display process for the diagnosis menu in accordance with a job history of the MFP according to the first embodiment.

FIG. 6 is a view showing a job history.

FIG. 7 is a view showing an example of a top screen on which preferential display items are preferentially displayed in the diagnostic menu by a process in a step S505 in FIG. 5.

FIG. 8 is a flowchart showing a preferential display process for the diagnosis menu in accordance with a diagnosis history of the MFP according to the first embodiment.

FIG. 9 is a view showing the diagnosis history.

FIG. 10 is a view showing an example of a top screen after a process in a step S805 in FIG. 8.

FIG. 11 is a flowchart showing a preferential display process for the diagnosis menu in accordance with installed functions of the MFP according to the first embodiment.

FIG. 12 is a view showing an example of a top screen after a process in a step S1105 in FIG. 11.

FIG. 13 is a sequential chart showing a preferential display process for a diagnosis menu according to an accumulated diagnosis frequency of a plurality of MFPs on a network according to a second embodiment.

FIG. 14 is a view showing a FAX diagnosis history of the MFP and a FAX diagnosis history of another MFP on the network.

FIG. 15 is a view showing a system diagnosis history and a system status in FIG. 1.

FIG. 16 is a view showing an example of a top screen after a process in a step S1308 in FIG. 13.

### DESCRIPTION OF THE EMBODIMENTS

Hereafter, embodiments according to the present invention will be described in detail by referring to the drawings. The following embodiments do not limit the invention according to the scope of claims, and all combinations of features described in the embodiments are not necessarily essential to the solving means of the present invention. In the following description, the image processing apparatus may be referred to as a multifunction machine, a multifunction peripheral, or an MFP.

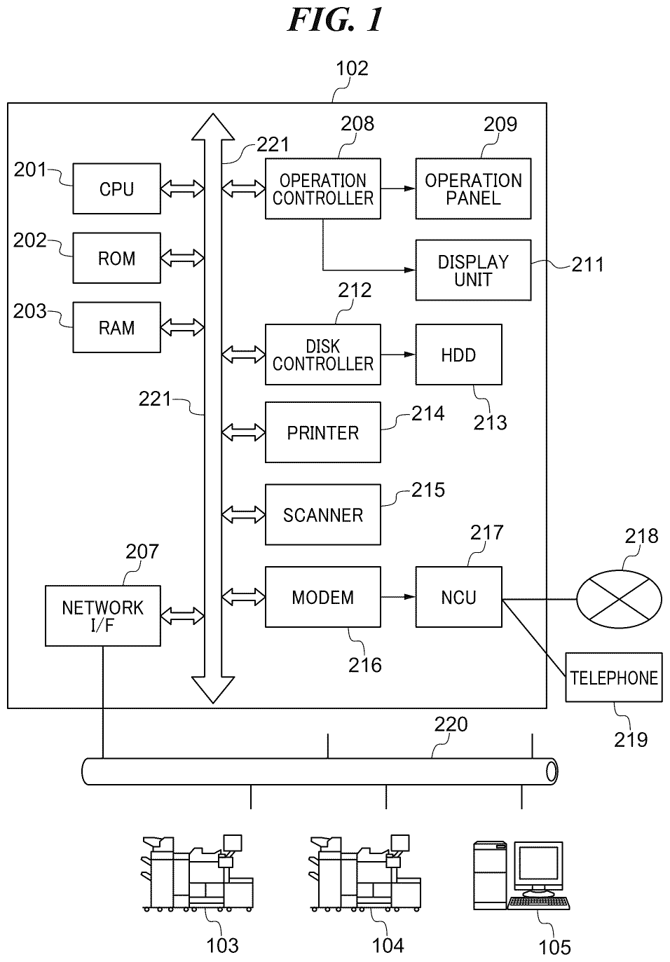

FIG. 1 is a block diagram showing a hardware configuration of the MFP 102 as the image processing apparatus of the present invention.

In FIG. 1, the MFP 102 includes devices, such as a CPU 201, a ROM 202, a RAM 203, a network I/F 207, an operation controller 208, a disk controller 212, a printer 214, a scanner 215, a modem 216. These devices are mutually connected via a system bus 121.

The CPU 201 executes software stored in the ROM 202 or, for example, an HDD (Hard Disk Drive) 213 connected to the disk controller 212. The CPU 201 totally controls the plurality of devices connected to the system bus 121. The HDD 213 may be used as a temporary storage area for an image in some cases.

The RAM 203 functions as a main memory, a work area, etc. of the CPU 201. The operation controller 208 controls various buttons, an operation panel 209, a display unit 211, etc. provided in the MFP 102. The disk controller 212 controls the HDD 213.

The network I/F 207 bidirectionally exchanges data with other MFPs 103 and 104 having the same hardware and software configuration as the MFP 102, a server 105, or a network device (not shown) via a network 220.

The printer 214 is a printing unit for printing on a paper sheet, which is achieved by an electrophotographic method. The printing method may not be particularly limited to the electrophotographic method.

The scanner 215 is an image reading unit for reading an image printed on a paper sheet. Note that the scanner 215 may be equipped with an ADF (Automatic Document Feeder) (not shown) as an option so as to automatically read a plurality of documents by the ADF.

The modem 216 is a device that demodulates modulated signals received from an external FAX (not shown) via a telephone network 218, and conversely modulates signals generated in the MFP 102 and sends them to the telephone network 218. An NCU 217 is an interface to control circuits between the modem 216, the telephone network 218, and a telephone 219. Specifically, the NCU 217 detects a signal coming from the telephone network 218 and transmits the signal to the modem 216 or the telephone 219, or transmits a signal from the modem 216 to an external FAX (not shown) via the telephone network 218. The NCU 217 also transfers a signal from the telephone 219 to the telephone network 218 and transmits the signal to an external telephone (not shown). The public network (telephone network 218) may not be directly connected to the NCU 217, but may be connected to the NCU 217 via a TA (Terminal Adapter), an extension exchange, or the like.

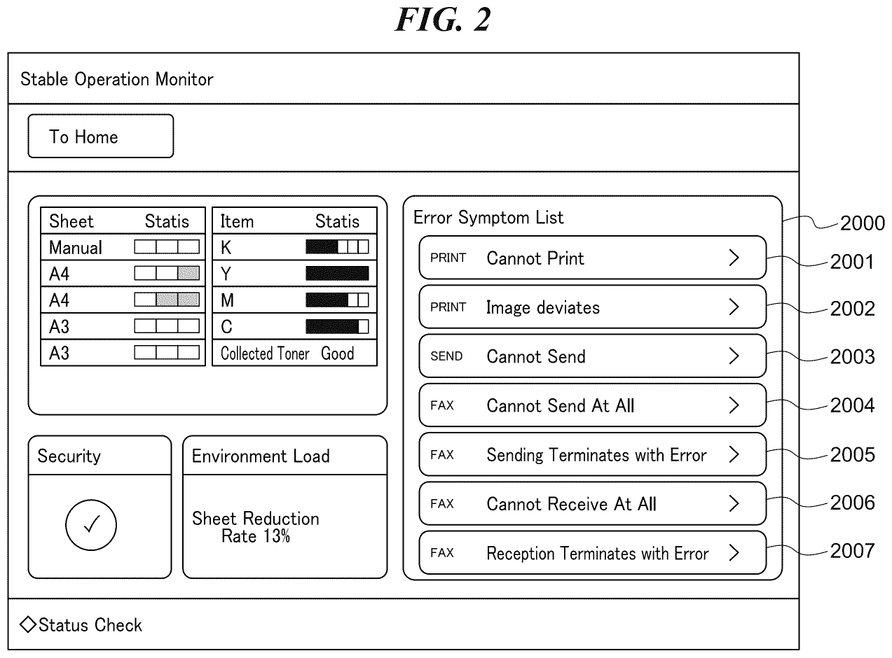

FIG. 2 is a view showing an example of a top screen displayed on the display unit 211 for a user to instruct diagnosis corresponding to an error symptom.

As shown in FIG. 2, the top screen (display means) includes a menu display area 2000 for displaying diagnostic menus 2001 to 2007 so that a user can select. The diagnostic menus 2001 to 2007 are buttons in which error symptoms of various functions related to image process provided by the MFP 102 are described. When the user presses one of the diagnostic menus 2001 to 2007 (user's selection), the CPU 201 (diagnosis means) starts a trouble handling (diagnosis process) prepared for the error symptom described in the pressed diagnostic menu.

In the present embodiment, a case where the various functions provided by the MFP 102 include PRINT, SEND, and FAX will be described below. The PRINT means an image printing function. The SEND is a generic name of image transmission functions, such as Email, SMB, FTP, I-FAX, and WebDav. The FAX means a function of transmitting and receiving an image between remote places using a telephone line and printing the received image on the receiving side.

Note that the various functions provided by the MFP 102 shown in FIG. 2 are examples, and other functions, such as copying, may be included. The diagnostic menus shown in FIG. 2 are also merely examples, and these are not limiting. Further, when a diagnostic menu for starting a diagnosis process that takes time is pressed, the top screen may transition to a diagnostic process screen (not shown) to display that the diagnostic process is being performed.

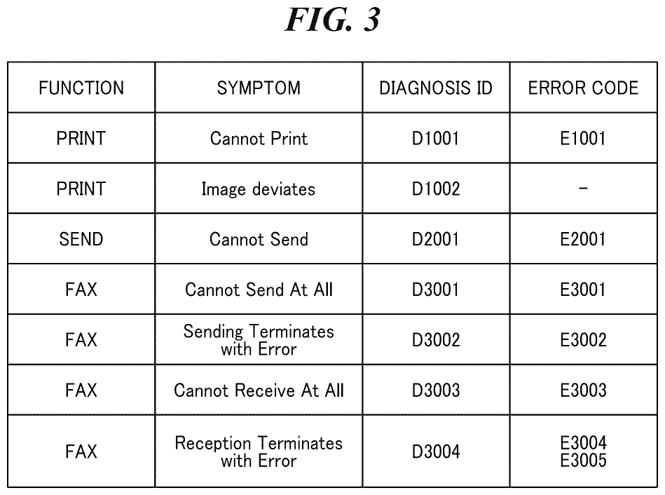

FIG. 3 is a view showing associations between diagnosis IDs and error codes that define contents of the diagnostic processes started by pressing the diagnostic menus 2001 to 2007, and functions and error symptoms that are indicated in the respective diagnostic menus.

In FIG. 3, a diagnosis ID is a character string that defines a content of a diagnostic process that is started when a button of each diagnosis menu is pressed, and an error code is a character string that is issued when an error symptom described in each diagnostic menu occurs. A diagnostic menu is associated with a corresponding diagnosis ID, and is also associated with a corresponding error code. In this way, a content to be diagnosed is determined in advance for each diagnostic menu, and the optimum diagnosis can be performed for each error symptom.

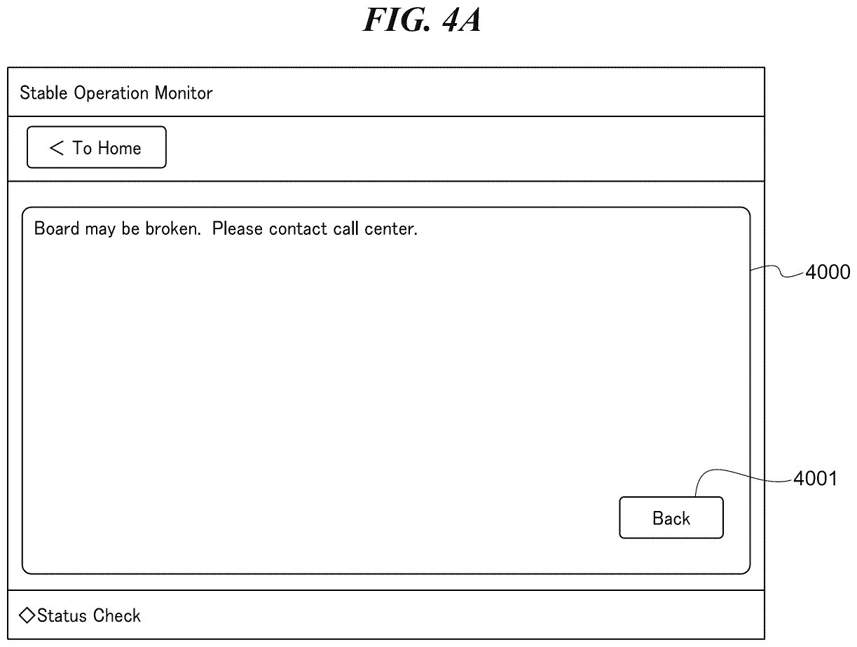

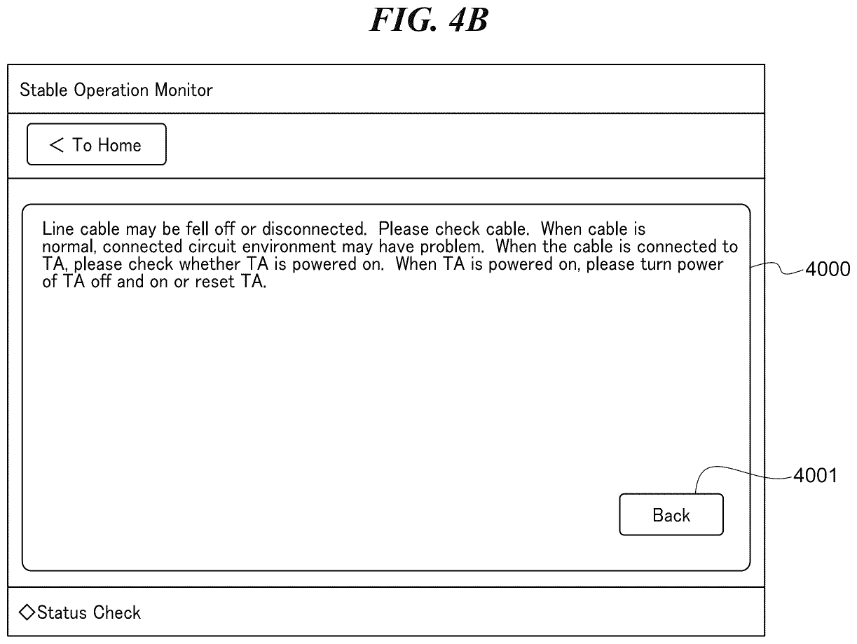

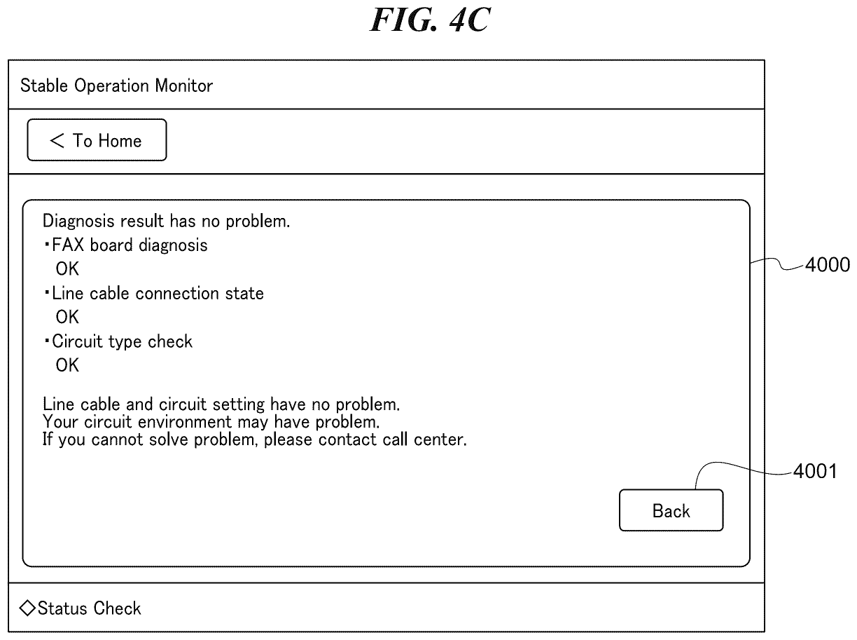

When the diagnostic menu 2004 (“FAX Cannot Send At All”) is selected on the top screen in FIG. 2, the top screen transitions to a screen indicating a diagnostic result of the associated diagnostic process (the diagnosis ID is D3001) shown in FIG. 3. Examples of the screens at this time are shown in FIG. 4A to FIG. 4C. Different result screens are displayed according to the symptoms of the device diagnosed by the diagnosis process. As an example, FIG. 4A shows a screen example in a case where a failure of a FAX board (hereinafter, simply referred to as a board failure) is diagnosed, FIG. 4B shows a screen example in a case where a line cable disconnection is diagnosed, and FIG. 4C shows a screen example in a case where mismatch of a circuit type is diagnosed. A diagnostic result display area 4000 and a back button 4001 for returning the screen display are displayed in common on each screen. The result screens in FIGS. 4A to 4C are displayed when the diagnostic process is completed.

In addition, when a diagnosis menu other than the diagnosis menu 2004 is selected on the top screen in FIG. 2, the top screen similarly transitions to the screen displaying a diagnosis result of an associated diagnosis process shown in FIG. 3.

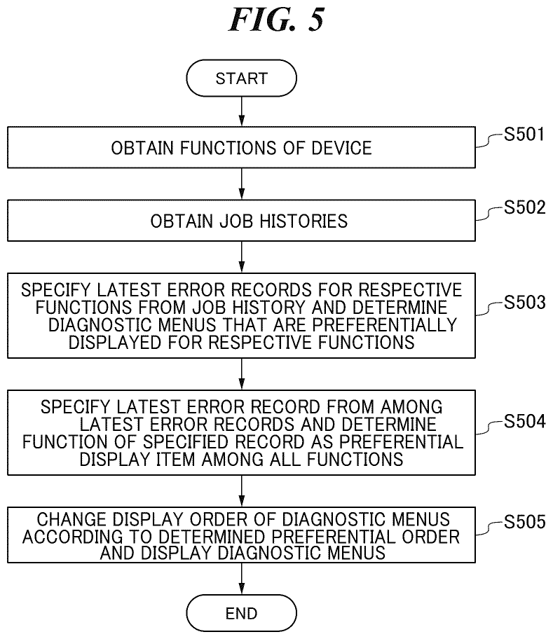

Next, a preferential display process to preferentially display a diagnostic menu in accordance with a job history of the MFP 102 when displaying the top screen will be described using a flowchart in FIG. 5. The preferential display here means to change the display order of the diagnostic menus 2001 to 2007 shown in FIG. 2. A series of processes are performed by reading a program that describes procedures described below and is executable by the MFP 102 from the ROM 202 onto the RAM 203 and then executing the program by the CPU 201.

First, in a step S501, the CPU 201 obtains information about functions provided by the MFP 102 from the HDD 213. Hereinafter, a case where the functions obtained here is PRINT, SEND, or FAX will be described as an example.

Next, in a step S502, the CPU 201 obtains a job history stored in the HDD 213.

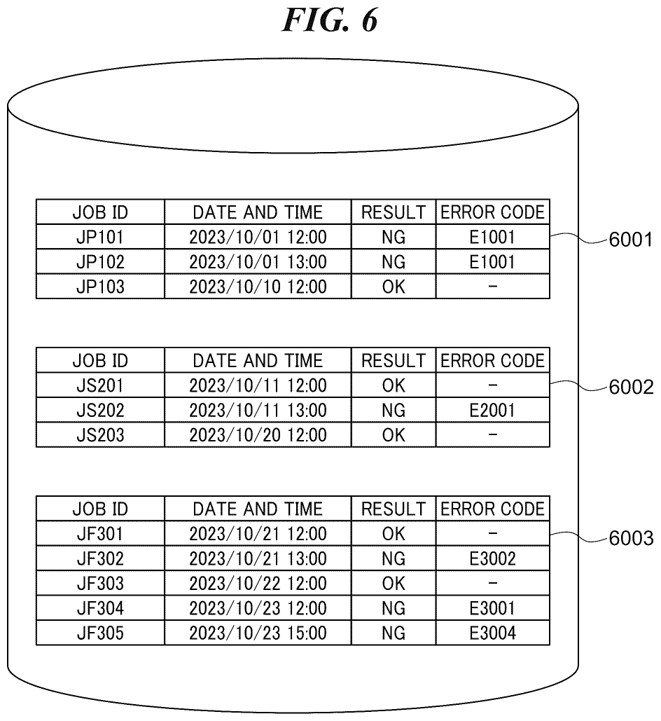

FIG. 6 is a view showing examples of the job histories of the respective functions of PRINT, SEND, and FAX, which are provided by the MFP 102, stored in the HDD 213.

In FIG. 6, records of which the job IDs are JP101 to JP103 are included in a PRINT job history 6001, records of which the job IDs are JS201 to JS203 are included in a SEND job history 6002, and records of which the job IDs are JF301 to JF305 are included in a FAX job history 6003.

Each record of the job histories 6001 to 6003 includes four pieces of information, that is, job ID information, date-and-time information, result information, and error code information.

The job ID information is information indicating an identification number issued for each job executed in the MFP 102. The date-and-time information is information indicating date and time when the MFP 102 started to execute each job. The result information is information indicating whether each job has been normally completed, and the result information of OK means normal completion and the result information of NG means abnormal completion other than the normal completion. The error code information is information indicating the abnormality content of the MFP 102 when each job has been abnormally completed. Although the job execution start date and time is used as the date and time indicated by the date-and-time information in the present embodiment, this is not limiting. For example, the job reception date and time or the job end date and time may be used instead.

The job histories 6001 to 6003 store all the jobs performed in the MFP 102, that is, the jobs that have been normally completed and the jobs that have been abnormally completed and for which the error codes have been issued (error jobs).

Referring back to FIG. 5, in a step S503, the CPU 201 specifies the records of the latest error jobs (error records) for the respective functions obtained in the step S501 from the job histories obtained in the step S502. Although the method of extracting the error record from the result of the job history is exemplified as the method of specifying the error record here, the method is not limited thereto. For example, the error record may be specified by extracting the job to which the error code is issued. Thereafter, the CPU 201 determines a diagnostic menu (preferential display item) to be preferentially displayed by referring to the comparison table in FIG. 3 from the error code associated with the specified error record.

Referring to the date-and-time information of the respective job histories shown in FIG. 6, the latest error record in the PRINT job history 6001 is JP102, the latest error record in the SEND job history 6002 is JS202, and the latest error record in the FAX job history 6003 is JF305. Therefore, the preferential display diagnostic menus of the respective functions are determined to be “Cannot Print” associated with E1001 for PRINT, “Cannot Send” associated with E2001 for SEND, and “Reception Terminates with Error” associated with E3004 for FAX.

Referring back to FIG. 5, in the next step S504, the CPU 201 specifies the function of the latest error record among the latest error records for the respective functions specified in the step S503, and determines the specified function as the preferential display item among the functions.

Here, since the latest error record among the latest error records for the respective functions specified in the step S503 is JF305 of FAX, the preferential display item between the functions is determined as FAX.

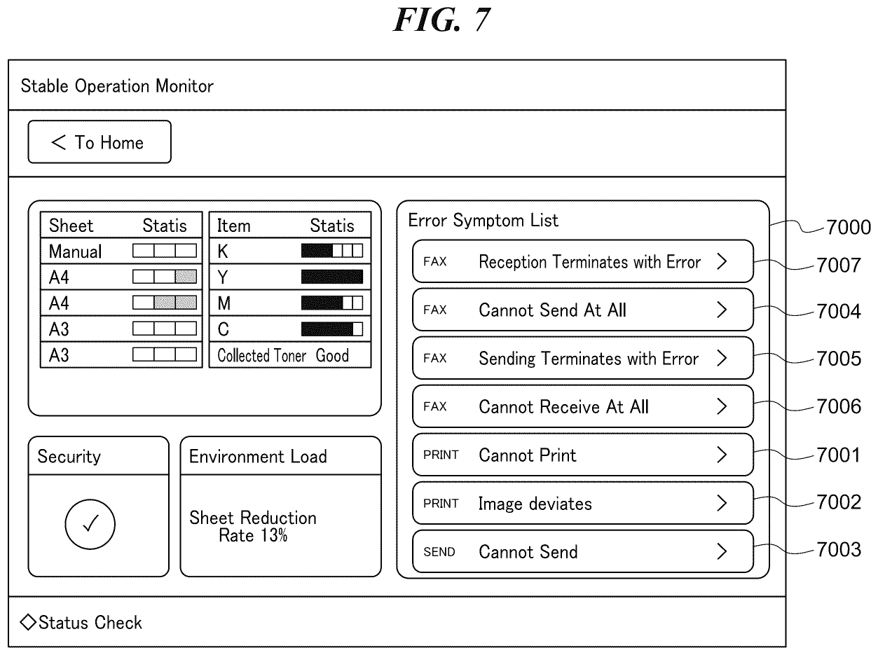

Referring back to FIG. 5, in the next step S505, the CPU 201 (determination means) changes the display order of the diagnostic menus based on the determination contents in the steps S503 and S504 as shown in a top screen shown in FIG. 7.

In FIG. 7, since the preferential display item among the functions is determined to be FAX in the step S504, the FAX diagnostic menus are preferentially displayed with respect to the PRINT diagnostic menus 7001 and 7002 and the SEND diagnostic menu 7003. Since the preferential display diagnostic menu in the FAX function is determined to be “Reception Terminates with Error” in the step S503, the diagnostic menu 7007 is preferentially displayed with respect to the diagnostic menus 7004 to 7006.

Although the preferential display method in each function or among functions is a method of simply displaying the item of the latest error record preferentially in FIGS. 5 to 7, another preferential display method, such as a method of preferentially displaying the items in order from the latest error record, may be used. Instead of changing the display order, the preferential item may be highlighted by changing the display color or the size of the character, changing the preferential item to a bold character, or adding a mark indicating preferential display, so that the user can easily understand the diagnostic menu that is preferentially displayed. Further, although FIG. 6 shows the example in which the job histories of the respective functions are recorded in the HDD 213, the entire job history of all the functions of the MFP 102 may be recorded in the HDD 213 in order of date and time.

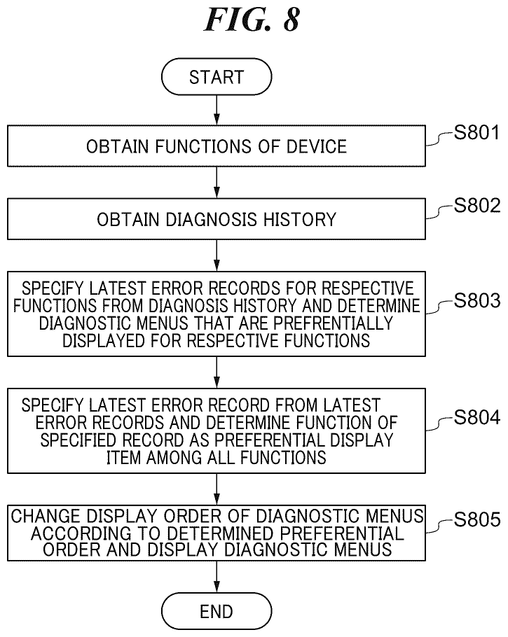

Next, a preferential display process to preferentially display a diagnostic menu in accordance with a diagnosis history of the MFP 102 when displaying the top screen will be described using a flowchart in FIG. 8. The preferential display here means to change the display order of the diagnostic menus 2001 to 2007 shown in FIG. 2. The diagnosis history is a job history of the diagnostic process executed when the user presses one of the diagnostic menus on the top screen. A series of processes are performed by reading a program that describes procedures described below and is executable by the MFP 102 from the ROM 202 onto the RAM 203 and then executing the program by the CPU 201.

First, in a step S801, the CPU 201 obtains information about functions provided by the MFP 102 from the HDD 213. Hereinafter, a case where the functions obtained here is PRINT, SEND, or FAX will be described as an example.

Next, in step S802, the CPU 201 obtains the diagnostic history stored in the HDD 213.

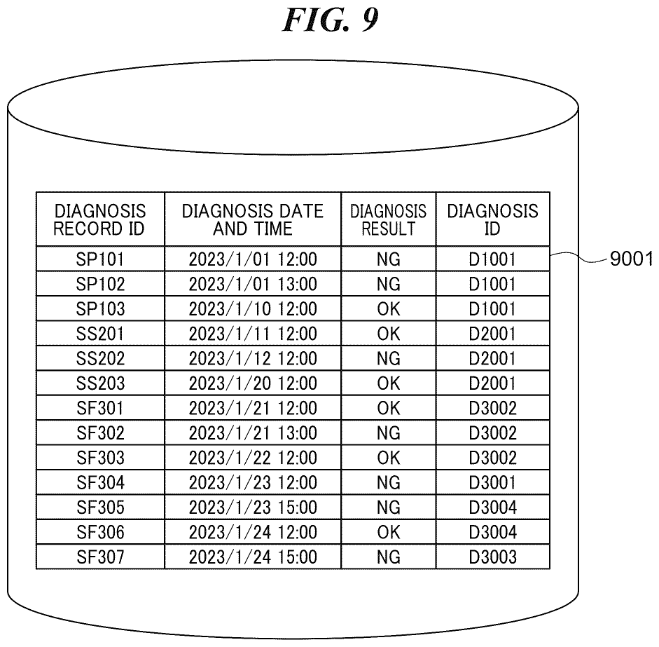

FIG. 9 is a view showing an example of a diagnosis history 9001 of the functions of PRINT, SEND, and FAX, which are provided by the MFP 102, stored in the HDD 213.

In FIG. 9, SP101 to SP103 are included in the PRINT diagnosis history, SS201 to SS203 are included in the SEND diagnostic history, and SF301 to SF307 are included in the FAX diagnostic history.

Each record of the diagnosis history 9001 includes four pieces of information, that is, diagnosis record ID information, diagnosis date-and-time information, diagnosis result information, and diagnosis ID information.

The diagnosis record ID information is information indicating an ID number issued for each job (diagnostic job) of the diagnostic process executed in the MFP 102. The diagnostic date-and-time information is information indicating date and time when the MFP 102 started to execute a diagnostic job. The diagnosis result information is information indicating whether the diagnosis result is an error (NG) or not (OK). When it is determined that there is no problem in the MFP 102 as the diagnostic result, the diagnosis result information is set to OK. When it is determined that there is a content that can be improved in the MFP 102, the diagnosis result information is set to NG. The diagnosis ID information is information indicating an ID number for identifying a diagnosis content to be performed in the MFP 102.

Referring back to FIG. 8, in a step S803, the CPU 201 specifies the latest error records for the respective functions obtained in the step S801 from the diagnosis history obtained in the step S802. Thereafter, the CPU 201 determines diagnostic menus to be preferentially displayed in the respective functions by referring to the comparison table in FIG. 3 based on the diagnosis IDs of the latest error records specified for the respective functions. The error record indicates a record of which the diagnosis result is NG in the diagnosis history.

When referring to the date-and-time information of the diagnostic history 9001 shown in FIG. 9, the latest error record in the PRINT diagnostic history is SP102, the latest error record of the SEND diagnostic history is SS202, and the latest error record of the FAX diagnostic history is SF307. Therefore, the preferential display diagnostic menus of the respective functions are determined to be “Cannot Print” associated with D1001 for PRINT, “Cannot Send” associated with D2001 for SEND, and “Cannot Receive At All” associated with D3003 for FAX.

Referring back to FIG. 8, in the next step S804, the CPU 201 specifies the function of the latest error record among the latest error records for the respective functions specified in the step S803, and determines the specified function as the preferential display item among the functions.

Here, since the latest error record among the latest error records for the respective functions specified in the step S803 is SF307 of FAX, the preferential display item among the functions is determined as FAX.

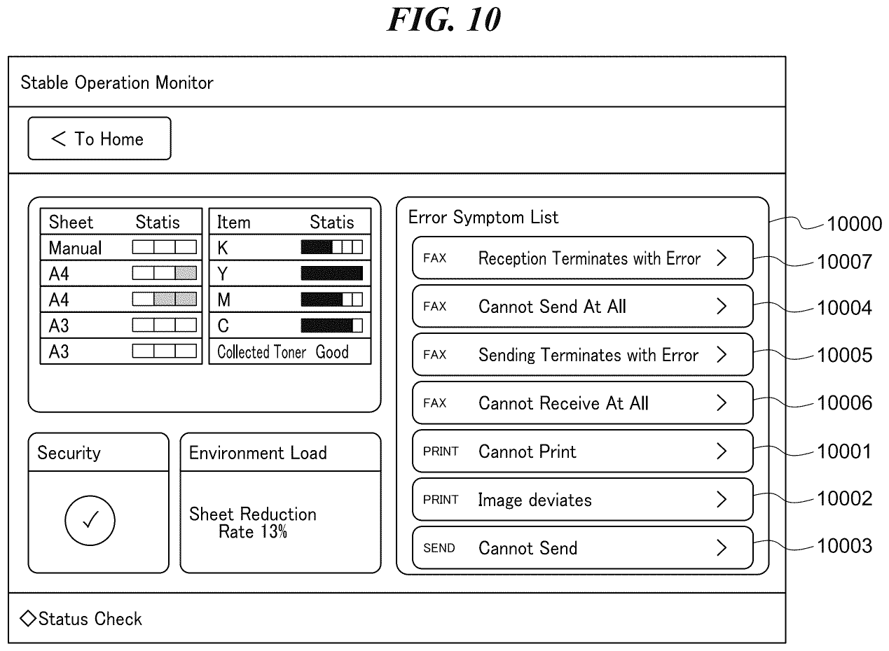

Referring back to FIG. 8, in the next step S805, the CPU 201 changes the display order of the diagnostic menus based on the contents determined in the steps S803 and S804, as shown in atop screen in FIG. 10.

In FIG. 10, since the preferential display item between the functions is determined to be FAX in the step S804, the FAX diagnostic menus are preferentially displayed with respect to the PRINT diagnostic menus 10001 and 1002 and the SEND diagnostic menu 10003. Since the priority display diagnostic menu in the FAX function is determined as “Cannot Receive At All” in the step S803, the diagnostic menu 10006 is preferentially displayed with respect to the diagnostic menus 10004, 10005, and 10007.

In addition, although the preferential display method in each function or among functions is a method of simply displaying the item of the latest diagnosis record preferentially in FIGS. 8 to 10, another preferential display method, such as a method of preferentially displaying the items in order from the latest error record, may be used. Further, although FIG. 9 shows an example in which the entire diagnostic history of the MFP 102 is recorded in the HDD 213, the diagnostic histories for the respective functions may be recorded in the HDD 213 in order of date and time.

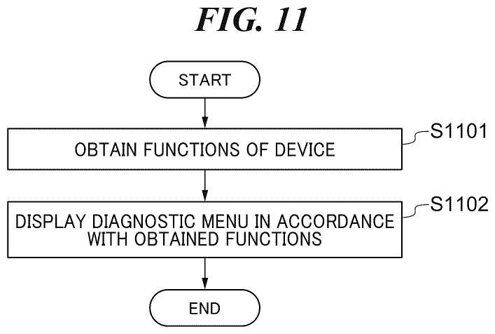

Next, a preferential display process of preferentially displaying a diagnostic menu according to functions installed in the MFP 102 when a top screen is displayed will be described with reference to a flowchart in FIG. 11. The preferential display here is to narrow and display appropriate items of the diagnosis menus 2001 to 2007 shown in FIG. 2. The installed functions are functions that are actually provided by the MFP 102 among functions that can be provided by the MFP 102 installing predetermined hardware and software. A series of processes are performed by reading a program that describes procedures described below and is executable by the MFP 102 from the ROM 202 onto the RAM 203 and then executing the program by the CPU 201.

First, in a step S1101, the CPU 201 (obtaining means) obtains information about functions (installed functions) provided by the MFP 102 from the HDD 213. Hereinafter, a case where the installed functions obtained here are PRINT and SEND, and FAX is not obtained as the installed function will be described as an example.

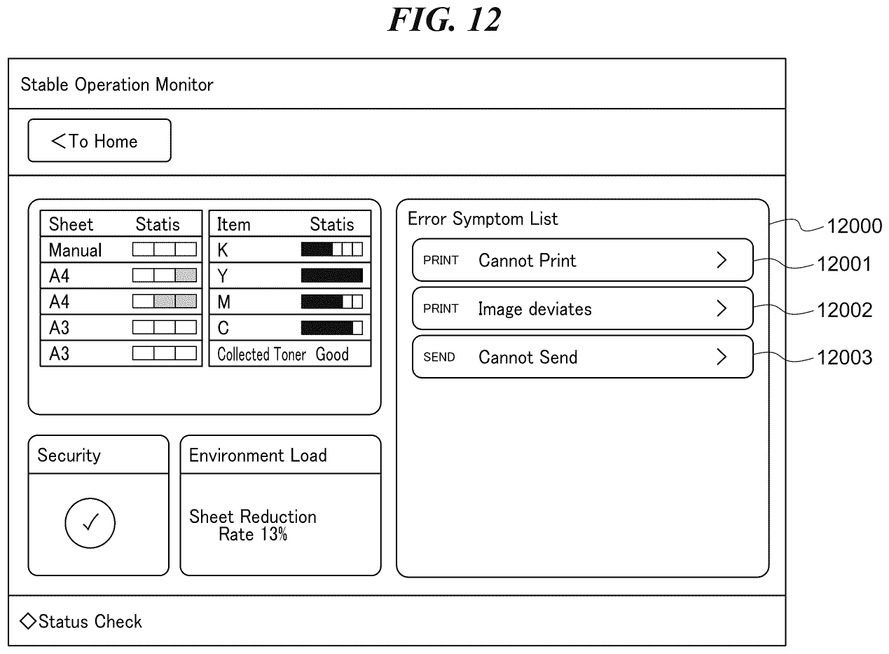

Next, in a step S1102, the CPU 201 changes the display order of the diagnostic menus based on the information about the installed functions obtained in the step S1101, as shown in a top screen in FIG. 12.

In the step S1101, PRINT and SEND are obtained as the installed functions, but FAX is not obtained. Therefore, in a step S1102, the CPU 201 displays the PRINT diagnostic menus 12001 and 12002 and the SEND diagnostic menu 12003 on the top screen, but does not display a FAX diagnostic menu as shown in FIG. 12.

Note that, although the example in which the FAX diagnosis menu of the function that is not installed is hidden (is not displayed) on the top screen has been described in the present embodiment, this is not limiting as long as the user cannot instruct to start the diagnostic process associated with the FAX diagnosis menu on the top screen. For example, the diagnostic menu of the function that is not installed may be displayed in a grayed-out manner on the top screen, and the diagnostic process may not be started even when the user presses button of the diagnosis menu that is displayed in the grayed-out manner.

In the present embodiment, the display method of the plurality of diagnostic menus on the top screen in accordance with the information indicating the state of the MFP 102, that is, which diagnostic menu is preferentially displayed (preferential display) or whether displaying and hiding (not-displaying) is switched (displaying/hiding switching), has been described above. Specifically, the example in which the preferential display or the switching between display and non-display is performed in accordance with the information indicating the state of the MFP 102, such as the error record in the job history, the error record in the diagnosis history, or the installed functions, has been shown, this is not limiting. For example, the priority display or the switching between display and non-display may be performed by combining the plurality of pieces of information indicating the state of the MFP 102. Further, for example, when the error record in the job history and the error record in the diagnosis history are combined, the error record in the job history may be preferentially displayed. Further, the preferential display may be determined according to frequency information, such as an error occurrence frequency or a diagnosis frequency. When the diagnostic menus are preferentially displayed, the frequency information as a basis may be displayed together. Further, the number of display items of the diagnosis menu of each function on the top screen may be variable, and the number of display items may be increased or decreased in association with a determination logic of the preferential display items. Further, the display may be switched to a fixed menu display without performing the preferential display described in the present embodiment.

Next, a second embodiment will be described. Hereinafter, the same reference numerals are used for the same components as those in the first embodiment among the hardware configuration and the software configuration in the present embodiment, and the duplicated description will be omitted. Although not shown in FIG. 1, the server 105 includes a CPU, a ROM, a RAM, and an HDD having the same functions as those of the CPU 201, ROM 202, RAM 203, and HDD 213 in the MFP 102.

In the first embodiment, the preferential display process is executed according to the state of the MFP 102 (the error record in the job history or the diagnostic history, the installed functions, or the like). In contrast, in the present embodiment, the preferential display process is executed according to not only the state of the MFP 102 but also the state of the entire system.

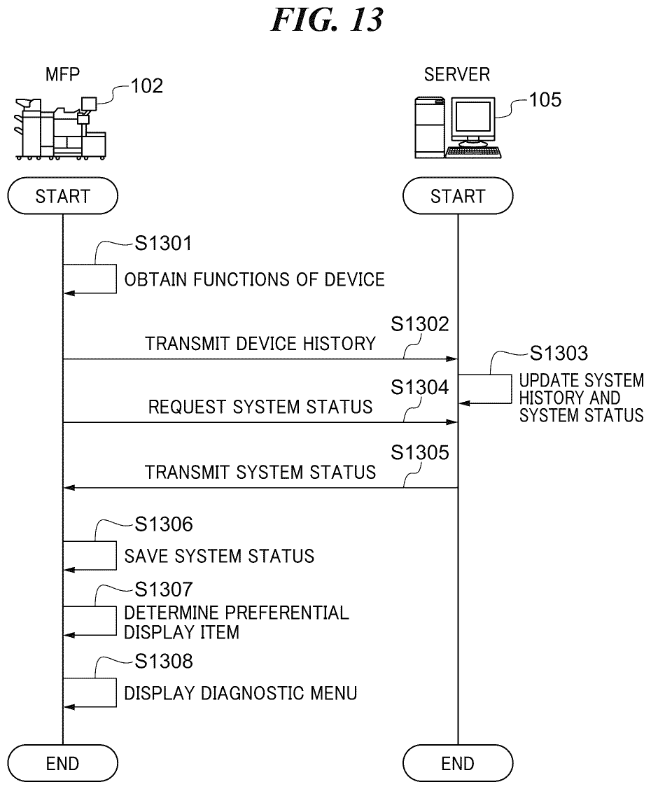

A preferential display process for preferentially displaying diagnostic menus according to accumulated diagnosis frequencies of the MFPs 102 to 104 on the network 220 in displaying a top screen will be described with reference to a sequence in FIG. 13. The accumulated diagnosis frequencies of the MFPs 102 to 104 are the total numbers of diagnoses performed to the MFPs 102 to 104 for the respective diagnosis IDs. The series of processes of the MFP 102 in this sequence are performed by reading a program that describes procedures described below and is executable by the MFP 102 from the ROM 202 onto the RAM 203 and then executing the program by the CPU 201. Similarly, a series of processes of the server 105 in this sequence are performed by reading a program that describes procedures described below and is executable by the server 105 from the ROM onto the RAM and then executing the program by the CPU.

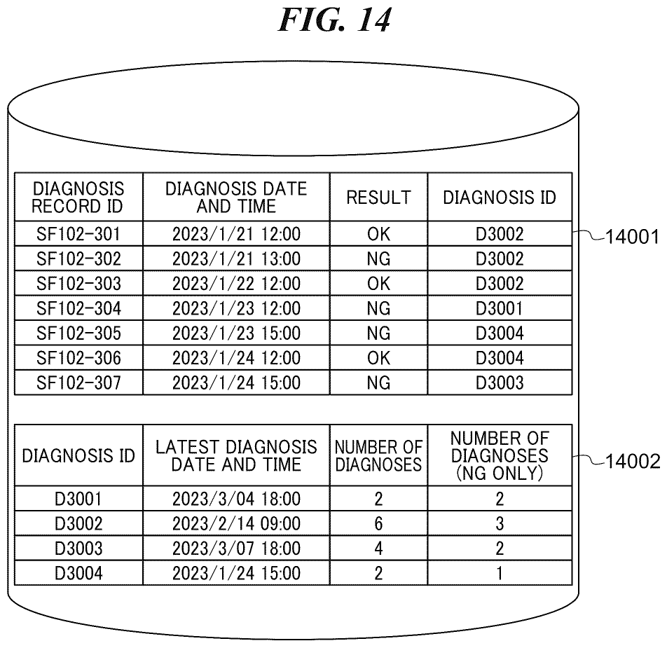

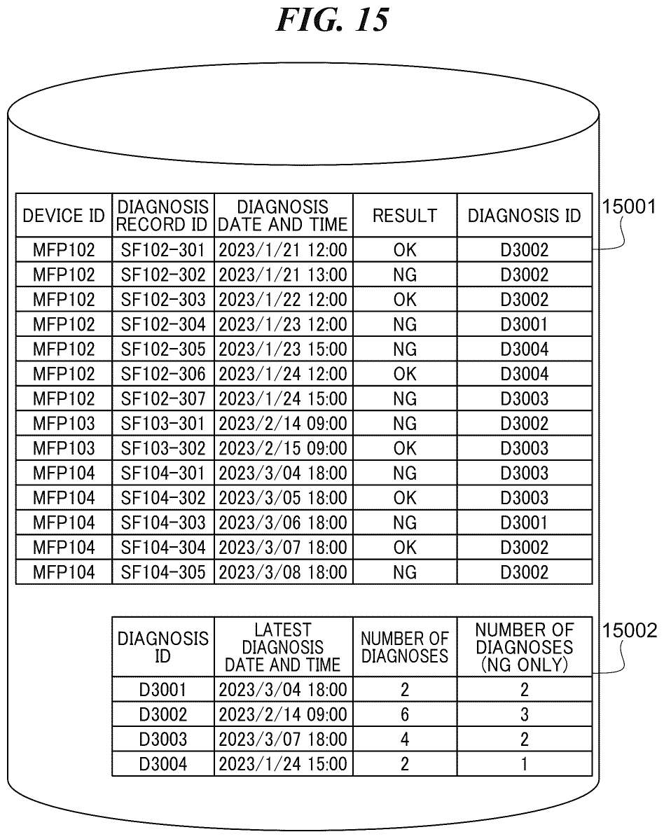

In the present embodiment, a FAX diagnosis history 14001 provided by the MFP 102 and a system status 14002 including the accumulated diagnosis frequencies of the MFPs 102 to 104 obtained from the server 105 shown in FIG. 14 are stored in the HDD 213 of the MFP 102. Moreover, in the present embodiment, a system history 15001 that is a diagnosis history of the entire system including the MFPs 102 to 104 and a system status 15002 including the accumulated diagnosis frequency of the entire system shown in FIG. 15 are stored in the HDD of the server 105.

First, in a step S1301, the CPU 201 of the MFP 102 obtains information about functions provided by the MFP 102 from the HDD 213. Hereinafter, the function obtained here is only FAX, and the diagnosis history stored in the HDD 213 is only the FAX diagnostic history 14001. In addition, a case where only the diagnostic menus 2004 to 2007 in FIG. 2 are displayed on the top screen will be described as an example.

Next, in a step S1302, the CPU 201 of the MFP 102 transmits the FAX diagnostic history 14001 stored in the HDD 213 to the server 105, and the process proceeds to a step S1304. When receiving the FAX diagnostic history 14001 from the MFP 102, the CPU of the server 105 updates the system history 15001 and the system status 15002 in a step S1303.

In the next step S1304, the CPU 201 of the MFP 102 requests the system status from the server 105. In response to the request from the MFP 102, the CPU of the server 105 transmits the latest system status 15002 to the MFP 102 in a step S1305.

Next, when receiving the system status 15002 transmitted from the server 105 in the step S1305, the CPU 201 of the MFP 102 stores the received system status 15002 as the system status 14002 in the HDD 213 in a step S1306.

Next, in a step S1307, the CPU 201 (a determination means) of the MFP 102 specifies the diagnosis ID with the highest diagnosis frequency using the system status 15002, and determines the symptom of the specified diagnosis ID as the diagnostic menu to be preferentially displayed in accordance with the comparison table in FIG. 3. In the example in FIG. 14, the diagnosis ID specified in the step S1307 is D3002, and therefore, the diagnostic menu in which “Reception Terminates with Error” is described is determined as the diagnostic menu to be preferentially displayed.

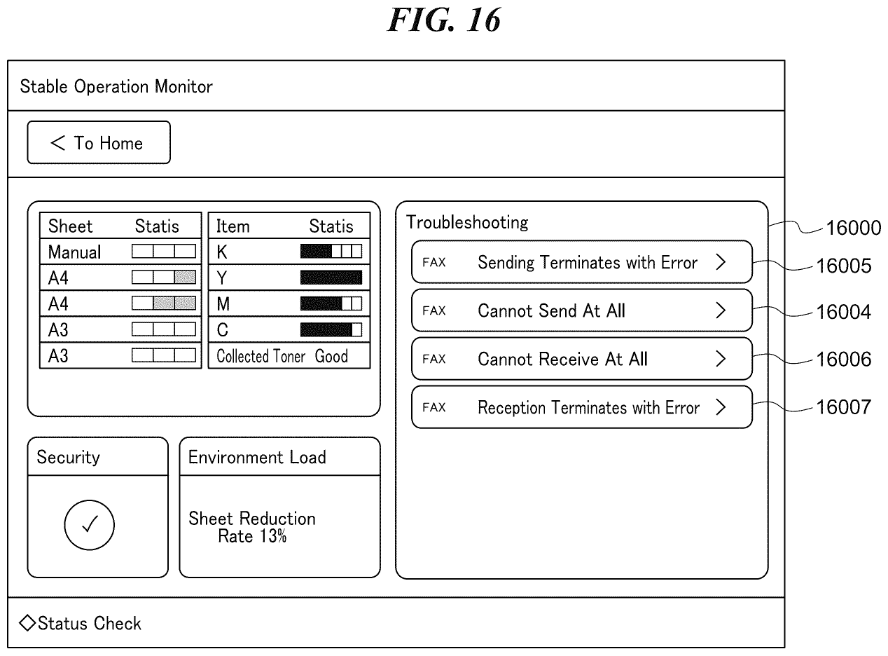

Next, in a step S1308, the CPU 201 of the MFP 102 preferentially displays the diagnostic menu determined in the step S1307, as shown in a top screen in FIG. 16. In FIG. 16, since the diagnostic menu to be preferentially displayed in the step S1307 is determined to be the diagnostic menu describing “Sending Terminates with Error”, the diagnostic menu 16005 is preferentially displayed with respect to other diagnostic menus 16004, 16006, and 16007.

Although the example in which the diagnosis history held by the MFP 102 and the system status held by the server 105 are transmitted and received when the MFP 102 displays the top screen is described in the present embodiment, they may be performed at other timings such as the timing of activation.

Further, although FIGS. 13 to 16 show the example of preferentially displaying the item having the large diagnosis frequency in the entire system from the system situation as a simple preferential display method, a logic of preferentially displaying the item in accordance with NG frequency of the diagnosis results or the latest diagnosis date and time may be employed.

Further, a logic that selects a preferential item based on the history of the device (the MFP 102 here, own device) that displays the system status and the top screen may be configured. For example, a logic that selects a preferential item from the history of the own device by giving the highest priority and then from the system status may be configured.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-033092, filed Mar. 5, 2024, which is hereby incorporated by reference herein in its entirety.

What is claimed is:

1. An image processing apparatus that executes at least one function about an image process in response to a user operation, the image processing apparatus comprising:
a memory device that stores a set of instructions; and
at least one processor that executes the set of instructions to:
display diagnostic menus describing error symptoms, which may occur in the image processing apparatus, related to the at least one function so as to be selectable by a user;
perform, when the user selects one of the diagnosis menus displayed, a diagnosis process corresponding to an error symptom described in the diagnosis menu selected by the user; and
determine a display method of the diagnostic menus according to a state of the image processing apparatus.

2. The image processing apparatus according to claim 1, wherein the at least one processor executes the set of instructions to determine a diagnostic menu to be preferentially displayed from the diagnostic menus.

3. The image processing apparatus according to claim 2, wherein the at least one processor executes the set of instructions to preferentially display a diagnosis menu associated with a latest error occurred in the image processing apparatus.

4. The image processing apparatus according to claim 3, wherein the information about the latest error occurred is obtained from a job history of the image processing apparatus.

5. The image processing apparatus according to claim 2, wherein a diagnosis history that is the job history of the diagnosis process includes information indicating whether a diagnosis result is an error, and wherein the at least one processor executes the set of instructions to preferentially display a diagnosis menu associated with a latest diagnosis record of which the diagnosis result is an error.

6. The image processing apparatus according to claim 2, wherein the at least one processor executes the set of instructions to:
obtain an installed function actually provided by the image processing apparatus among functions that can be provided by the image processing apparatus; and
hide a diagnostic menu of the function that is not installed among the diagnostic menus.

7. The image processing apparatus according to claim 2, wherein the at least one processor executes the set of instructions to:
obtain an installed function actually provided by the image processing apparatus among functions that can be provided by the image processing apparatus; and
display a diagnostic menu of the function that is not installed in a grayed-out manner among the diagnostic menus.

8. An image processing apparatus that executes at least one function about an image process in response to a user operation, the image processing apparatus comprising:
a memory device that stores a set of instructions; and
at least one processor that executes the set of instructions to:
display diagnostic menus describing error symptoms, which may occur in the image processing apparatus, related to the at least one function so as to be selectable by a user;
perform, when the user selects one of the diagnosis menus displayed, a diagnosis process corresponding to an error symptom described in the diagnosis menu selected by the user; and
determine a display method of the diagnostic menus according to a status of a system constituted by the image processing apparatus and another image processing apparatus.

9. A control method for an image processing apparatus that executes at least one function about an image process in response to a user operation, the control method comprising:
displaying diagnostic menus describing error symptoms, which may occur in the image processing apparatus, related to the at least one function so as to be selectable by a user;
performing, when the user selects one of the diagnosis menus displayed, a diagnosis process corresponding to an error symptom described in the diagnosis menu selected by the user; and
determining a display method of the diagnostic menus according to a state of the image processing apparatus.

10. A non-transitory computer-readable storage medium storing a control program causing a computer to execute a control method for an image processing apparatus that executes at least one function about an image process in response to a user operation, the control method comprising:
displaying diagnostic menus describing error symptoms, which may occur in the image processing apparatus, related to the at least one function so as to be selectable by a user;
performing, when the user selects one of the diagnosis menus displayed, a diagnosis process corresponding to an error symptom described in the diagnosis menu selected by the user; and
determining a display method of the diagnostic menus according to a state of the image processing apparatus.
